(19) United States
(12) Patent Application Publication
(10) Pub. No.: US 2010/0214091 A1
(43) Pub. Date: Aug. 26, 2010

(54) VERFAHREN ZUM BETREIBEN EINES FELDGERATES, SOWIE KOMMUNIKATIONSEINHEIT UND FELDGERAT

(75) Inventors: Werner Thoren, Steinen (DE); Jorg Reinkensmeier, Steinen (DE); Ulrich Kaiser, Basel (CH)

Correspondence Address: BACON & THOMAS, PLLC, 625 SLATERS LANE, FOURTH FLOOR, ALEXANDRIA, VA, 22314-1176, US

(73) Assignee: Endress + Hauser Process Solution AG, Reinach (CH)

(21) Appl. No.: 12/452,276

(22) PCT Filed: Nov. 14, 2008
(86) PCT No.: PCT/EP2008/065563

§ 371 Date: Apr. 21, 2010

(30) Foreign Application Priority Data
Nov. 15, 2007 (DE) 10 2007 054 924.7

(51) Int. Cl. G08B 1/08

(52) U.S. Cl. 340/539.1

(57) ABSTRACT

A method for operating a field device of an industrial process, and/or automation, technology, wherein at least one communication unit is connected with the field device for sending and/or for receiving a signal. An electrical power loss of the communication unit and/or a need of the communication unit for electrical energy, especially in the form of electrical voltage, are/is reduced for an adjustable period of time. Furthermore, a communication unit, as well as to a field device with a communication unit is provided for.

The invention relates to a method for operating a field device of industrial process, and/or automation, technology, wherein there is connected with the field device at least one communication unit for sending and/or for receiving a signal. Furthermore, the invention relates to a communication unit of industrial process, and/or automation, technology for sending and/or receiving signals, and having at least one communication resistor, wherein the communication unit is connectable with a field device of industrial process, and/or automation, technology. Furthermore, the invention relates to a field device of industrial process, and/or automation, technology. The field device comprises, for example, a measuring transducer or an actuator.

In modern industrial process, and/or automation, technology, for example, communication between field devices, i.e. between measuring devices, control rooms or actuators, takes place via a shared data bus using the HART protocol. HART (Highway Addressable Remote Transducer) is a standardized and widely distributed, communication system for construction of industrial fieldbusses. HART is superimposed on the likewise widely distributed 4 . . . 20 mA standard (for transmission of analog sensor signals), so that present lines of the older system can be directly used and the two systems operated together. For data transmission, the “Frequency Shift Keying” (Bell 202) method is utilized, wherein, on the low frequency, analog signal, a high-frequency oscillation (+/−0.5 mA) is superimposed. Thus, especially, the signals are out-coupled via the signal lines supplying the field device with energy. The field devices are, in such case, especially, two conductor devices.

A development of modern industrial process, and/or automation, technology is in the direction of cableless communication and energy supply. For this, either the field devices are automatically able to communicate e.g. via radio, or corresponding communication units are provided, which are connected with the field devices and which care for the cableless communication. The type of energy supply aims, in such case, to achieve autarky, wherein, for example, freely present energy sources (e.g. light) or batteries are used. In the case of batteries, it is necessary that these be replaced from time to time, so that a highest possible lifetime is desired.

If it is, now, for example, provided that a field device is connected with a communication unit, wherein from the field device a HART communication takes place, then the signal is usually tapped for further processing via a communication resistor. The voltage drop across this communication resistor leads, however, to an energy loss.

An object of the invention is, consequently, to provide, for the cableless application of field devices, a facilitating, especially, of their operation, wherein the energy, and/or voltage, requirement is reduced.

This object is solved by the invention by a method for operating a field device, by a communication unit for a field device and by a field device.

The invention solves the object with a method for operating a field device of industrial process, and/or automation, technology, wherein there is connected with the field device at least one communication unit for sending and/or for receiving a signal, wherein an electrical power loss of the communication unit, and/or a need of the communication unit for electrical energy, especially in the form of electrical voltage, is reduced for an adjustable period of time. The communication unit (another name would be communication adapter, or in the case, that via this unit also the energy supply is implemented, then power supplying, and communication, adapter) is, in such case, connected, for example, either releasably and temporarily with the field device, or the communication unit is a component of the field device. In the first case, the communication unit, which serves for the receiving, sending, preprocessing and/or forwarding of signals and/or for the energy supply of the field device, is, thus, separated spatially from the field device, but connectable, or coupleable, with it. According to the invention, the power loss, which occurs in the communication unit, is reduced, at least for an adjustable period of time, i.e. energy is saved. Furthermore, also by the reducing of the voltage requirement, energy is saved. The communication unit serves, in such case, for example, for receiving data of the field device (e.g. a measuring sensor) and for transmitting such to a superordinated unit or to another communication node. In an additional embodiment, the communication unit receives via radio a signal, or information, for the field device (e.g. an actuator) and transmits such correspondingly to the field device. Communication unit interfaces, thus, in an embodiment, via a first connecting unit with the field device—e.g. via cable—and via a second connecting unit with the superordinated unit or with other communication points—e.g. via radio. Associated with the timewise reducing of the power loss is a decreased need for energy, wherein, especially, the voltage requirement is reduced. I.e., there are time periods, in which a smaller voltage is needed and time periods in which a higher voltage is needed.

An embodiment of the method provides that at least one communication resistor in the communication unit is shunted for the adjustable period of time in such a manner that a voltage drop across the communication resistor is reduced and/or prevented. If communication takes place, for example, via the HART protocol, then the communication unit obtains the information signal to be transmitted in this embodiment via a tapping of an e.g. ohmic resistor, to which the 4 . . . 20 mA signal is applied. If the communication resistor is shunted for an adjustable period of time, then there is, for example, no voltage drop on this and there are no losses. In the simplest embodiment, this is implemented via a resistor bypass.

An embodiment of the method includes that HART signals are sent and/or received via the communication resistor. The field device is, in such case, especially, a two conductor device.

An embodiment of the method provides that the communication resistor is short circuited for the adjustable period of time. The short circuit effects, in such case, a direct shunting of the resistor and prevents, thus, effectively, a voltage drop and therewith a power loss on the resistor. In an embodiment, thus, the shunting can be implemented by a switch, which shunts, or short circuits, the communication resistor.

An embodiment of the method includes that the field device has at least one measuring transducer, that the measuring transducer is supplied with energy only for adjustable time periods, and that the electrical power loss of the communication unit and/or the need of the communication unit for electrical energy, especially in the form of electrical voltage, is reduced until the measuring transducer has reached a stable state following the obtaining of a supply of energy. Especially for autarkic operation, it is often provided, that measurements are performed not permanently, but, instead, only at certain times. In intervening times, the measuring transducers, or sensors, are placed in a sleep, or stand by, state, in which they require no, or only very little, energy. If such a measuring transducer is waked back up, a complete measuring is still not immediately possible, i.e. there is yet no measured value to be transferred. Therefore, the power loss of the communication unit is reduced not only when the measuring transducer is in the sleep state, but, instead, also after the waking up of the measuring transducer, until a stable state of the measuring transducer is reached. Criteria of a stable state are dependent e.g. on the type and version of the measuring transducer. Some measuring devices, e.g. many pressure measuring devices, measure almost directly after turn-on, while others need, in given cases, up to 15 seconds and more, e.g. fill-level measuring devices operating according to the time of flight principle. The method of the invention concerns, thus, especially, the energy optimized starting of HART devices.

The invention solves the object furthermore by a communication unit of industrial process, and/or automation, technology for sending and/or receiving signals, and having at least one communication resistor, wherein the communication unit is connectable with a field device of industrial process, and/or automation, technology, and wherein at least one shunting unit is provided, via which the communication resistor can be shunted for an adjustable period of time. The communication unit is embodied in such a manner that it is directly connectable (i.e. it can be coupled at least for transmission of signals) with a field device, e.g. with a measuring transducer or an actuator. The communication unit serves for communicating data, or signals, from the field device to a superordinated unit or to additional communication points, or for receiving data, or signals, for the field device and for transmitting such to this. According to the invention, the power loss of the communication unit is reduced over an adjustable period of time, in order, thus, to save energy. Therewith accompanies an increasing of the lifetime of an autarkic energy source for the energy supply of the field device, and/or the communication unit, as the case may be. The communication unit can, thus, also be referred to as a radio module. If at least one communication of the signals takes place via the HART protocol, then, especially, information is removed from the electrical signal via a communication resistor. The reduction of the power loss at this electrical resistor occurs, in such case, by a shunting of the same. For example, the shunting unit is a switch, which short circuits the communication resistor.

An embodiment of communication unit provides that at least one control unit is provided, which controls the shunting unit. Stored in this control unit is, for example, the time, which, after a starting of the field device connected with communication unit, the transmission resistance should be shunted. In an additional embodiment, an input means is provided, via, which this shunting time can be suitably set. In an additional embodiment, the control unit ascertains the suitable shunting period automatically.

Moreover, the invention solves the object with a field device of industrial process, and/or automation, technology having at least one communication unit according to at least one of the preceding embodiments. The field device comprises, for example, a measuring transducer or an actuator. The field device is, in such case, in this embodiment, associated with a communication unit, which is embodied according to at least one of the preceding embodiments.

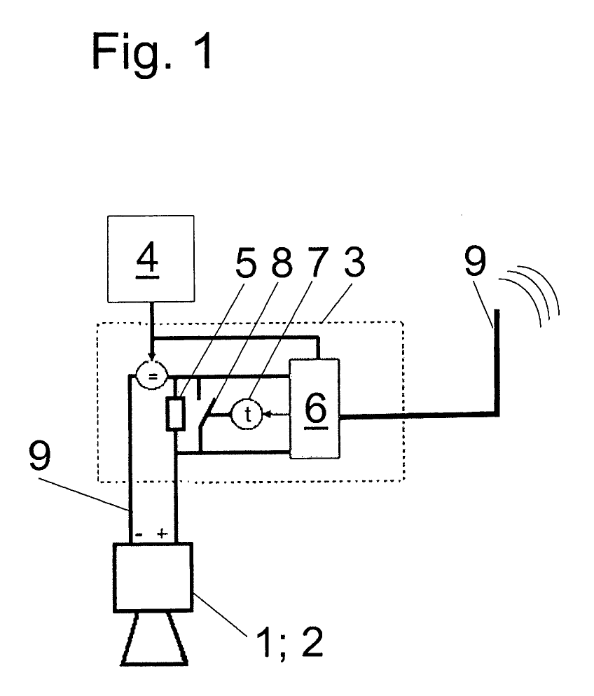

The invention will now be explained in greater detail on the basis of the appended drawing, in which the sole FIG. 1 shows a schematic construction thereof.

FIG. 1 shows schematically a field device 1, which is, here, for example, a measuring transducer, or a sensor, 2 for determining and/or monitoring a fill level of a medium in a container via the application of microwaves or radar. In another embodiment, the field device 1 is, for example, an actuator.

The field device 1, or the measuring transducer 2, is connected mechanically and/or electrically with a communication unit 3, which serves for energy supply and the wider communication of signals, or measured values, of the measuring transducer 2 within, for example, a wireless network. Communication unit 3 is embodied for connection with the measuring transducer 2 in such a manner that it receives signals from the measuring transducer 2 and communicates these further. If the field device 1 is an actuator, then the communication unit 3 receives signals for these. However, also a combination of sending and receiving signals from, or to, the field device 1 is possible.

Communication unit 3 is connected with an energy source 4, which is, for example, a battery. Also, measuring transducer 2 is fed from this energy source 4. Measuring transducer 2 is a two-conductor, field device. Communication unit 3 is, in this embodiment, thus, especially, a battery operated, power supplying, and communication, adapter.

Communication of the signals from the measuring transducer 2 to the communication unit 3 occurs by means of HART signals. I.e., superimposed on the 4 . . . 20 mA signal on the input of the measuring transducer 2 are the signals to be transmitted. In communication unit 3, the signals, or information, are tapped via, or extracted from, the communication resistor 5. Communication unit 3 uses two connecting units 9: The one connecting unit 9 is for the electrical lines, with which the measuring transducer 2 is supplied with energy, or via which the measuring transducer 2 transmits by means of HART communication its signals to communication unit 3. The other connecting unit 9 is here an antenna, with which the signals of the measuring transducer 2 are, for example, transmitted within the network.

For putting the invention into practice, there is provided in the communication unit 3 a control unit 6, such as, for example, a microcontroller. The control unit 6 has via a timing relay 7 influence on a shunting unit 8, via which the power loss of the communication unit 3 is reduced. The shunting unit 8 is, in the illustrated example, a switch, by means of which the communication resistor 5 can be directly short circuited, whereby no electrical loss occurs on it. Preferably, communication resistor 5 is, in each case, shunted exactly when a starting, thus a “turning on”, of the field device 1 is performed. The shunting time is, in such case, set in such a manner that the communication resistor 5 is first not shunted, i.e. is free for receiving signals, when the measuring transducer 2 is in a stable state. Through the shunting unit 8—here executed concretely as a resistor bypass—it is achieved, that the communication resistor 5 is only active, when also a valid measurement signal is present for transmission, i.e., in the case of start-up of the device, energy consumption is minimized, until the device measures, or until a stable measured value is produced.

A shunting time suitable for the connected HART device 2 is selectively or combinedly, factory set, is mechanically, or electrically, set on-site, or set from a control room or by operating personnel (e.g. via a potentiometer) or it is electronically controlled, or controlled via software. For the latter variant, the suitable shunting time is selectively configured or combinedly configured in the software, ascertained on the basis of information furnished, or stored, in the software for particular device types, read-out from the connected device or adaptively ascertained and optimized, e.g. by software or by operating personnel. For the adjusting, thus, in given cases, the technical information of the HART device to be connected is necessary, in which data is to be found concerning how long the device requires after turn-on, until a stable measured value is present. This period of time is often not fixed, but, instead, dependent on configuration parameters for smoothing, filtering, integration, average formation, etc. The shunting period is, thus, set, in given cases, ex factory or on-site or the information concerning the required starting times are stored for the device types (or more exactly, for possible configurations of device types) in the software of the “battery operated, power supplying, and communication adapter”, i.e. the communication unit 3. The “battery driven, power supplying, and communication adapter” would, in such case, in an embodiment, read out via the HART protocol the type of the connected device 2 and, when required, also its relevant configuration parameters, in order to compare the information then with lists stored in its software, or to ascertain therefrom the necessary shunting time. In an additional embodiment, the adapter/communication unit 3 ascertains the, in each case, suitable value via adaptive ascertaining of the shunting time by “trials” in ongoing operation. As criterion, whether the measuring device is currently delivering a valid measured value, or still not doing so, evaluation off the HART status information for the device and for the particular measured value can be used (status “OK”). Since an adaptive ascertaining requires a number of—suboptimal—trials, until the optimal value is found, this can be further improved by storing, or furnishing, information for starting behavior in the particular HART device and reading out, with targeting, via the HART protocol, as the reading in of the shunting time from the device, for the optimizing of further startings of the device.

### LIST OF REFERENCE CHARACTERS

1 field device
2 measuring transducer
3 communication unit
4 energy source
5 communication resistance
6 control unit
7 timing relay
8 shunting unit
9 connecting unit

1-8. (canceled)

9. A method for operating a field device of industrial process, and/or automation, technology, comprising the steps of:
connecting at least one communication unit with the field device for sending and/or for receiving a signal; and
reducing for an adjustable period of time an electrical power loss of the communication unit and/or a need of the communication unit for electrical energy, especially in the form of electrical voltage.

10. The method as claimed in claim 9, wherein:
at least one communication resistor in the communication unit is shunted for said adjustable period of time in such a manner that a voltage drop across the communication resistor is reduced and/or prevented.

11. The method as claimed in claim 10, wherein:
HART signals are sent and/or received via the communication resistor.

12. The method as claimed in claim 10, wherein:
the communication resistor is short circuited for the adjustable period of time.

13. The method as claimed in claim 9, wherein:
the field device comprises at least one measuring transducer;
the measuring transducer is supplied with energy only for adjustable time periods; and
the electrical power loss of the communication unit and/or the need of the communication unit for electrical energy, especially in the form of electrical voltage, is reduced until the measuring transducer, following obtaining a supply of energy, has reached a stable state.

14. A communication unit of an industrial process, and/or automation, technology for sending and/or receiving signals, comprising:
at least one communication resistor, wherein the communication unit is connectable with a field device of industrial process, and/or automation, technology; and
at least one shunting unit is provided, via which the communication resistor is shunted for an adjustable period of time.

15. The communication unit as claimed in claim 14, wherein:
at least one control unit is provided, which controls the shunting unit.

16. A field device of an industrial process, and/or automation, technology having at least one communication unit, comprising:
at least one communication resistor, wherein the communication unit is connectable with a field device of industrial process, and/or automation, technology; and
at least one shunting unit is provided, via which the communication resistor is shunted for an adjustable period of time.
